(19) United States
(12) Patent Application Publication
(10) Pub. No.: US 2023/0335329 A1
(43) Pub. Date: Oct. 19, 2023

(54) COIL COMPONENT

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kiyoshi AIZAWA, Yokkaichi-shi, Mie (JP)

(21) Appl. No.: 18/042,519

(22) PCT Filed: Jul. 29, 2021
(86) PCT No.: PCT/JP2021/028207

§ 371 Date: Feb. 22, 2023

(30) Foreign Application Priority Data
Aug. 26, 2020 (JP) 2020-142466

(51) Int. Cl. H01F 27/08; H01F 27/28

(52) U.S. Cl. CPC H01F 27/2804; H01F 27/08; H01F 2027/2809

(57) ABSTRACT

In a coil component, a coil portion includes wiring layers laminated on a substrate. The wiring layers include a first wiring layer wound on a first surface side of the substrate and a second wiring layer wound on a second surface side of the substrate relative to the first wiring layer. At least a portion of the second wiring layer is wider than at least a portion of the first wiring layer.

### CROSS REFERENCE TO RELATED APPLICATIONS

This application is the U.S. national stage of PCT/JP2021/028207 filed on Jul. 29, 2021, which claims priority of Japanese Pat. Application No. JP 2020-142466 filed on Aug. 26, 2020, the contents of which are incorporated herein.

### TECHNICAL FIELD

The present disclosure relates to a coil component.

### BACKGROUND

A technique such as that disclosed in JP 2010-114195A is disclosed as a technique for forming a coil on a substrate. A vehicle substrate coil disclosed in JP 2010-114195A includes a first coil portion and a second coil portion each constituted by layers of conductive patterns.

In the technique disclosed in JP 2010-114195A, the coils are formed by layers of conductive patterns, but with this type of coil, increasing the width of a conductor in order to suppress the resistance value leads to the size of the coil required for ensuring the necessary winding number becoming relatively large. On the other hand, with this type of coil, reducing the width of a conductor in order to suppress the size of the coil leads to a relative increase in the resistance value, which is likely to result in more heat being generated. Thus, when the width of conductor layers is made equal, a decision has to be made between setting the width so as to prioritize a reduction in the resistance value or setting the width so as to prioritize a reduction in size.

It is an object of the present disclosure to provide a coil component with which the size of a wiring layer on a first surface side of a substrate can be easily suppressed and the resistance value of a wiring layer on the second surface side can be easily suppressed.

### SUMMARY

A coil component that is one aspect of the present disclosure is a coil component in which a coil portion is provided on a substrate, wherein the coil portion includes a plurality of wiring layers laminated on the substrate. The plurality of wiring layers include a first wiring layer with a wound configuration on a first surface side of the substrate, and a second wiring layer with a wound configuration on a second surface side of the substrate relative to the first wiring layer. At least a portion of the second wiring layer is wider than at least a portion of the first wiring layer.

### Advantageous Effects

The coil component which is one embodiment of the present disclosure makes it easier to suppress the size of the wiring layer on one surface side of the substrate and easier to suppress the resistance value of the wiring layer on the second surface side.

### BRIEF DESCRIPTION OF DRAWINGS

FIG. 1 is a cross-sectional view conceptually illustrating a cross-section of a coil component according to a first embodiment.

FIG. 2 is a diagram for conceptually describing a first wiring layer of the coil component according to the first embodiment.

FIG. 3 is a diagram for conceptually describing a second wiring layer of the coil component according to the first embodiment.

FIG. 4 is a diagram for conceptually describing a third wiring layer of the coil component according to the first embodiment.

FIG. 5 is a diagram for conceptually describing a fourth wiring layer of the coil component according to the first embodiment.

### DETAILED DESCRIPTION OF PREFERRED EMBODIMENTS

Embodiments of the present disclosure will be listed and described below. Note that the features of (1) to (9) illustrated below may be combined in any manner provided no contradiction arises.

### Feature 1

A coil component according to a first feature is a coil component in which a coil portion is provided on a substrate, wherein the coil portion includes a plurality of wiring layers laminated on the substrate, the plurality of wiring layers include a first wiring layer with a wound configuration on a first surface side of the substrate, and a second wiring layer with a wound configuration on a second surface side of the substrate relative to the first wiring layer, and at least a portion of the second wiring layer is wider than at least a portion of the first wiring layer.

In the coil component of feature 1, at least a portion of the second wiring layer disposed on the second surface side of the substrate is wider than at least a portion of the first wiring layer disposed on the first surface side of the substrate. Accordingly, the coil component makes it easier to suppress the size of the wiring layer on the first surface side of the substrate and easier to suppress the resistance value of the wiring layer on the second surface side.

### Feature 2

The coil component of feature 2 according to the coil component of feature 1 has the following features. The first wiring layer includes one or more first conductor patterns that are continuous with a constant width, and the second wiring layer includes one or more second conductor patterns that are continuous with a constant width. The constant width of all of the second conductor patterns of the second wiring layer is larger than the constant width of the all of the first conductor patterns of the first wiring layer.

In the coil component of feature 2, at least at the portions of the first conductor patterns and the second conductor patterns that are continuous with a constant width, it is possible to ensure a larger width for the second wiring layer disposed on the second surface side of the substrate than the width of the first wiring layer disposed on the first surface side of the substrate.

### Feature 3

The coil component of feature 3 according to the coil component of features 1 or 2, the winding number of the first wiring layer is greater than the winding number of the second wiring layer.

In the first wiring layer of the coil component of feature 3 in which the conductor width is relatively suppressed, the inductance can be increased by relatively increasing the winding number, and thus an increase in the inductance in the wiring layer on the first surface side of the substrate can prioritized. On the other hand, in the second wiring layer of the coil component in which the winding number is relatively small, the resistance value can be suppressed by increasing the conductor width, and thus a reduction in the resistance value of the wiring layer on the second surface side of the substrate can be prioritized.

### Feature 4

The coil component of feature 4 according to any one of the coil components of feature 1 to 3, the first surface of the substrate is supported by a heat dissipation portion.

In the coil component of feature 4, the first surface of the substrate is a surface supported by the heat dissipation portion, and thus heat dissipation can be promoted on the first surface side of the substrate. The configuration where the first wiring layer is disposed on the first surface side of the substrate makes it easier to suppress the size of the wiring layer on the first surface side, but heat generation by the first wiring layer is of concern. In contrast, the coil component of (4) can promote heat dissipation on the first surface side, and thus the size of a wiring layer on the first surface side of the substrate can be suppressed while also suppressing heat generation.

### Feature 5

The coil component of feature 5 according to the coil component of any one of features 1 to 4 has the following features. In the coil component of feature 5, at least one of the first wiring layer and the second wiring layer includes a first annular pattern provided in an annular shape, and a second annular pattern provided in an annular shape on the outer side relative to the first annular pattern. At least a portion of the second annular pattern is wider than at least a portion of the first annular pattern.

In the coil component of feature 5, it is possible to ensure a larger width for the outer second annular pattern of which the path is likely to be long, and suppress the resistance voltage of the outer second annular pattern for which the resistance value is likely to be large.

### Feature 6

The coil component of feature 6 according to the coil component of any one of features 1 to 5 has the following features. The plurality of wiring layers include another wiring layer with a wound configuration, and the other wiring layer is connected in parallel to at least one of the first wiring layer and the second wiring layer.

In the coil component of feature 6, the other wiring layer is connected in parallel, and thus the resistance value of the wiring layer to which the other wiring layer is connected in parallel can be suppressed overall.

### Feature 7

The coil component of feature 7 according to the coil component of feature 6 has the following features. The other wiring layer includes a first other wiring layer that is connected in parallel to the first wiring layer, and a second other wiring layer that is connected in parallel to the second wiring layer.

In the coil component of feature 7, the resistance value of the parallel connection portion including the first wiring layer and the parallel connection portion including the second wiring layer can be suppressed.

### Feature 8

The coil component of feature 8 according to any one of the coil components of features 1 to 7 has the following features. The first wiring layer includes first linear patterns that are linear with a predetermined width, and the second wiring layer includes second linear patterns that are linear with a predetermined width. All of the second linear patterns of the second wiring layer are wider than all of the first linear patterns of the first wiring layer.

With the coil component of feature 8, the size of the wiring layer on the first surface side of the substrate can be more easily suppressed, and the resistance value of the wiring layer on the second surface side can be more easily suppressed. Feature 9

In the coil component of feature 9 according to any one of the coil components in features 1 to 8, the first wiring layer is in contact with the heat dissipation portion.

In the coil component of feature 9, bringing the heat dissipation portion into direct contact with the first wiring layer, of which heat generation is a concern, can more efficiently dissipate heat.

### FIRST EMBODIMENT

### 1. Overview of Coil Component

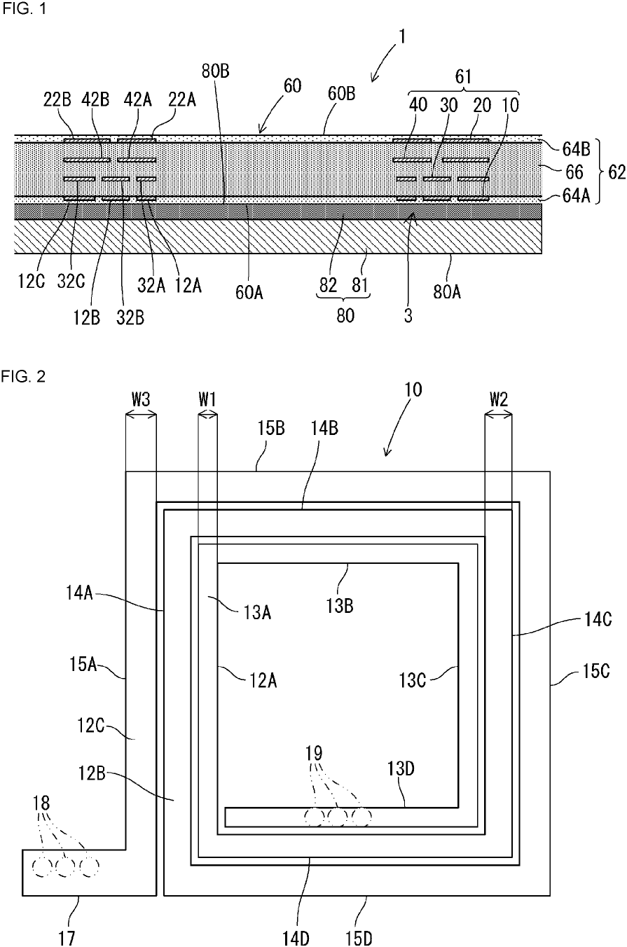

A coil component 1 shown in FIG. 1 is a vehicle coil component that is mounted in a vehicle. The coil component 1 is used as a part of an in-vehicle electronic device. The coil component 1 may be a component that functions as a part of a power supply circuit of an in-vehicle DC/DC converter or the like (for example, a transistor, filter, etc.), or a component that functions as a part of another in-vehicle device.

As shown in FIG. 1, the coil component 1 includes a substrate 60. The substrate 60 includes a substrate main body 62, a wiring portion 61, un-shown mounted components, and the like. The substrate 60 is provided with a layer-described coil portion 3. The coil component 1 is formed as a substrate coil. The coil portion 3 is formed as a laminated coil.

In the present specification, a first plate surface 60A, which is one plate surface in the thickness direction (plate thickness direction) of the substrate 60 corresponds to an example of a first surface. A second plate surface 60B, which is the other plate surface in the thickness direction (plate thickness direction) of the substrate 60, corresponds to an example of a second surface. The first plate surface 60A is an end surface on a heat dissipation portion 80 side in the thickness direction of the substrate 60. The second plate surface 60B is an end surface on a side that is opposite to the heat dissipation portion 80 side in the thickness direction of the substrate 60.

The heat dissipation portion 80 is a portion that dissipates heat while supporting the substrate 60. The first plate surface 60A (first surface) of the substrate 60 is a surface that is in direct contact with the heat dissipation portion 80 and is supported by the heat dissipation portion 80. The heat dissipation portion 80 has one or more heat dissipating materials, and functions so as to dissipate heat accumulated in the substrate 60. In FIG. 1, the heat dissipation portion 80 includes a first heat dissipation member 81 and a second heat dissipation member 82.

The second heat dissipation member 82 is interposed between the substrate 60 and the first heat dissipation member 81 while being sandwiched between the substrate 60 and the first heat dissipation member 81. The surface on the first side of the second heat dissipation member 82 is in contact with the surface on the second side of the first heat dissipation member 81. The surface on the second side of the second heat dissipation member 82 is in contact with the first plate surface 60A, which is the first surface of the substrate 60. The second heat dissipation member 82 may be made of, for example, a heat dissipating material that has fluidity such as grease, or be a solid heat dissipation member such as a heat dissipation sheet. It is desirable that the thermal conductivity of the second heat dissipation member 82 is greater than that of the substrate main body 62.

The first heat dissipation member 81 is a member that supports the substrate 60 via the second heat dissipation member 82. The surface on the second side of the first heat dissipation member 81 is in contact with the surface on the first side of the second heat dissipation member 82. The surface on the first side of the first heat dissipation member 81 may be exposed to a space where a gas is present, may be in contact with a liquid, or may be in contact with a solid including heat dissipating properties. The first heat dissipation member 81 is made of a metal material or the like with high heat dissipating properties, for example, and functions as a heat sink. The first heat dissipation member 81 may be provided with a heat dissipation fin or the like. It is desirable that the thermal conductivity of the first heat dissipation member 81 is greater than that of the substrate main body 62.

In the example shown in FIG. 1, the surface 80A of the heat dissipation portion 80 that is on the side opposite to the substrate 60 (specifically, the surface on the first side of the first heat dissipation member 81), is a surface that is exposed to a space where gas is present and is exposed to a gas such as air. Note that the surface 80A is not limited to this example, and may be a surface that is in contact with a liquid such as cooling water or in contact with a solid that has heat dissipating properties. When the surface 80A is configured to be in contact with cooling water, it is sufficient that the surface 80A forms a portion of a channel through which cooling water flows, or a portion of a pooling portion where cooling water is pooled.

The surface 80B on the substrate 60 side of the heat dissipation portion 80 (specifically, the surface on the second side of the second heat dissipation member 82) opposes the first plate surface 60A of the substrate 60 while being in contact with the first plate surface 60A. The first plate surface 60Amay be in contact with the surface 80B via an adhering medium such as an adhesive. Alternatively, the first plate surface 60A may be in direct contact with the surface 80B without another member being interposed therebetween.

The coil portion 3 includes wiring layers (a first wiring layer 10, a second wiring layer 20, and intermediate wiring layers 30 and 40), and insulating layers 64A, 64B, and 66. The first wiring layer 10, the second wiring layer 20, and the intermediate wiring layers 30 and 40, which are the plurality of wiring layers, are laminated on the substrate 60. The first wiring layer 10, the second wiring layer 20, and the intermediate wiring layers 30 and 40, which are the plurality of wiring layers, are all wiring patterns formed by a conductive layer. It is sufficient that the material of the first wiring layer 10, the second wiring layer 20, and the intermediate wiring layers 30 and 40 is a conductive material.

The insulating layers 64A, 64B, and 66 are plate-shaped insulation portions that form the substrate main body 62. The insulating layer 66 is a plate-shaped portion made of an insulating material such as a resin. The insulating layer 66 may be formed using a prepreg, for example, or have another configuration. The insulating layers 64A and 64B are covering layers that respectively cover both surfaces of the insulating layer 66. The insulating layers 64A and 64B may be formed using a resist, for example, or have another configuration.

As shown in FIG. 1, the first wiring layer 10 is a wiring layer that is disposed on the first plate surface 60A (first surface) side of the substrate 60 relative to the second wiring layer 20. Of the wiring layers that form the coil portion 3 (the first wiring layer 10, the second wiring layer 20, and the intermediate layers 30 and 40), the first wiring layer 10 is a wiring layer that is disposed closest to the first plate surface 60A in the thickness direction of the substrate 60. In the example shown in FIG. 1, the first wiring layer 10 is disposed on the surface on the first side of the insulating layer 66, and is embedded in the substrate main body 62 so as to be covered by the insulating layer 64A. In the present specification, the first wiring layer 10 forms the first wiring layer.

FIG. 2 is a diagram (plan view) for briefly describing the configuration of only the first wiring layer 10 of the coil component 1 as seen from above. Portions other than the first wiring layer 10 are omitted from FIG. 2. Note that the thickness direction of the substrate 60 is the vertical direction in the present specification. The first plate surface 60A side of the substrate 60 is the lower side and the second plate surface 60B side is the upper side.

As shown in FIG. 2, the first wiring layer 10 is a wiring layer wound in a coil shape. The first wiring layer 10 is disposed on a predetermined virtual plane that extends in a direction orthogonal to the thickness direction of the substrate 60, and is wound along this virtual plane.

The first wiring layer 10 includes annular patterns 12A, 12B, and 12C that are provided in annular shapes. In the example shown in FIG. 2, the first wiring layer 10 includes the annular patterns 12A, 12B, and 12C (three windings) that make three laps thereof, where the number of annular patterns (number of laps) corresponds to the winding number. That is, the winding number (number of turns) of the first wiring layer 10 is three. The winding number of the first wiring layer 10 is greater than the winding number of the layer-described second wiring layer 20.

Of the annular patterns 12A, 12B, and 12C forming the first wiring layer 10, the innermost annular pattern 12A corresponds to an example of a first annular pattern. The annular patterns 12B and 12C are provided in annular shapes on the outer side relative to the annular pattern 12A (first annular pattern). The annular patterns 12B and 12C correspond to examples of a second annular pattern. At least portions of the annular patterns 12B and 12C (second annular pattern) are wider than at least a portion of the annular pattern 12A (first annular pattern). Specifically, the annular patterns 12A, 12B, and 12C increase in width in an outward direction.

The annular pattern 12A includes one or more first conductor patterns that are continuous with a constant width. Specifically, the annular pattern 12A includes linear patterns 13A, 13B, 13C, and 13D that are linear and have a predetermined width W1. The linear patterns 13A, 13B, 13C, and 13D correspond to an example of a first linear pattern, and correspond to an example of a first conductor pattern. The linear patterns 13A, 13B, 13C, and 13D form an integrated conductor pattern. The annular pattern 12A is configured such that the linear patterns 13A, 13B, 13C, and 13D are continuous and form a polygonal shape (specifically, a square shape) and a frame shape.

The annular pattern 12B is a conductor pattern that continues from an end portion of the annular pattern 12A. The annular pattern 12B includes one or more first conductor patterns that are continuous with a constant width. Specifically, the annular pattern 12B includes linear patterns 14A, 14B, 14C, and 14D that are linear and have a predetermined width W2. The linear patterns 14A, 14B, 14C, and 14D correspond to an example of a first linear pattern, and correspond to an example of a first conductor pattern. The linear patterns 14A, 14B, 14C, and 14D form an integrated conductor pattern. The annular pattern 12B is configured such that the linear patterns 14A, 14B, 14C, and 14D are continuous and form a polygonal shape (specifically, a square shape) and a frame shape. The annular pattern 12B is disposed on the outer side of the annular pattern 12A so as to surround the annular pattern 12A. The total length of the annular pattern 12B is larger than the total length of the annular pattern 12A. The total area of the annular pattern 12B is greater than the total area of the annular pattern 12A.

The annular pattern 12C is a conductor pattern that continues from an end portion of the annular pattern 12B. The annular pattern 12C includes one or more first conductor patterns that are continuous with a constant width. Specifically, the annular pattern 12C includes linear patterns 15A, 15B, 15C, and 15D that are linear and have a predetermined width W3. The linear patterns 15A, 15B, 15C, and 15D correspond to an example of a first linear pattern, and correspond to an example of a first conductor pattern. The linear patterns 15A, 15B, 15C, and 15D form an integrated conductor pattern. The annular pattern 12C is configured such that the linear patterns 15A, 15B, 15C, and 15D are continuous and form a polygonal shape (specifically, a square shape) and a frame shape. The annular pattern 12C is disposed on the outer side of the annular patterns 12A and 12B so as to surround the annular patterns 12A and 12B. The total length of the annular pattern 12C is larger than the total length of the annular pattern 12B. The total area of the annular pattern 12C is greater than the total area of the annular pattern 12B.

In the first wiring layer 10, the relation between the widths W1, W2, and W3 is W1≤W2≤W3, and is more desirably W1<W2<W3. The first wiring layer 10 includes a connection portion 17 that is connected to an end portion of the annular pattern 12C.

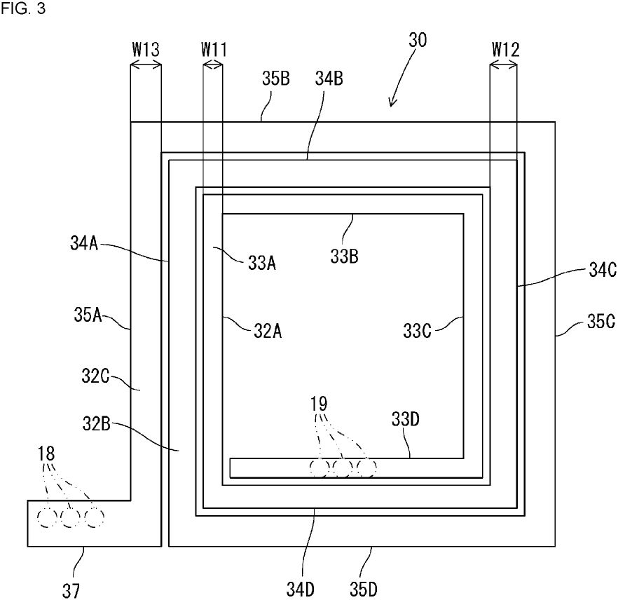

As shown in FIG. 1, the intermediate wiring layer 30 is a wiring layer that is disposed on the first plate surface 60A (first surface) side relative to the second wiring layer 20 in the substrate 60, and is disposed on the second plate surface 60B (second surface) side relative to the first wiring layer 10. In the example shown in FIG. 1, the intermediate layer 30 is embedded in the insulating layer 66. In the present specification, the intermediate wiring layer 30 is a second wiring layer. FIG. 3 is a diagram (plan view) for briefly describing the configuration of only the intermediate wiring layer 30 of the coil component 1 as seen from above. Portions other than the intermediate wiring layer 30 are omitted from FIG. 3.

As shown in FIG. 3, the intermediate wiring layer 30 is a wiring layer wound in a coil shape. The intermediate wiring layer 30 is disposed on a predetermined virtual plane that extends in a direction orthogonal to the thickness direction of the substrate 60, and is wound along this virtual plane. As shown in FIG. 3, the intermediate wiring layer 30 has the same shape as the first wiring layer 10 (FIG. 2).

The intermediate wiring layer 30 includes annular patterns 32A, 32B, and 32C that are provided in annular shapes. In the example shown in FIG. 3, the intermediate wiring layer 30 includes the annular patterns 32A, 32B, and 32C (three windings) that make three laps thereof, where the number of annular patterns (number of laps) corresponds to the winding number. The winding number of the intermediate wiring layer 30 is greater than the winding number of the layer-described second wiring layer 20. Of the annular patterns 32A, 32B, and 32C forming the intermediate wiring layer 30, the annular pattern 32A is the innermost annular pattern. The annular patterns 32B and 32C are provided in annular shapes on the outer side relative to the annular pattern 32A. At least portions of the annular patterns 32B and 32C are wider than at least a portion of the annular pattern 32A.

The annular pattern 32A includes one or more conductor patterns that are continuous with a constant width. Specifically, the annular pattern 32A includes linear patterns 33A, 33B, 33C, and 33D that are linear and have a predetermined width W11. The linear patterns 33A, 33B, 33C, and 33D form an integrated conductor pattern. The annular pattern 32A is configured such that the linear patterns 33A, 33B, 33C, and 33D are continuous and form a polygonal shape (specifically, a square shape) and a frame shape.

The annular pattern 32B is a conductor pattern that continues from an end portion of the annular pattern 32A. The annular pattern 32B includes one or more conductor patterns that are continuous with a constant width. The annular pattern 32B includes linear patterns 34A, 34B, 34C, and 34D that are linear and have a predetermined width W12. The linear patterns 34A, 34B, 34C, and 34D form an integrated conductor pattern. The annular pattern 32B is configured such that the linear patterns 34A, 34B, 34C, and 34D are continuous and form a polygonal shape (specifically, a square shape) and a frame shape. The annular pattern 32B is disposed on the outer side of the annular pattern 32A so as to surround the annular pattern 32A. The total length of the annular pattern 32B is larger than the total length of the annular pattern 32A. The total area of the annular pattern 32B is greater than the total area of the annular pattern 32A.

The annular pattern 32C is a conductor pattern that continues from an end portion of the annular pattern 32B. The annular pattern 32C includes one or more conductor patterns that are continuous with a constant width. The annular pattern 32C includes linear patterns 35A, 35B, 35C, and 35D that are linear and have a predetermined width W13. The linear patterns 35A, 35B, 35C, and 35D form an integrated conductor pattern. The annular pattern 32C is configured such that the linear patterns 35A, 35B, 35C, and 35D are continuous and form a polygonal shape (specifically, a square shape) and a frame shape. The annular pattern 32C is disposed on the outer side of the annular patterns 32A and 32B so as to surround the annular patterns 32Aand 32B. The total length of the annular pattern 32C is larger than the total length of the annular pattern 32B. The total area of the annular pattern 32C is greater than the total area of the annular pattern 32B.

In the intermediate wiring layer 30, the relation between the widths W11, W12, and W13 is W11≤W12≤W13, and is more desirably W11<W12<W13. The relation between widths of the first wiring layer 10 and the intermediate wiring layer 30 is W1 = W11, W2 = W12, and W3 = W13.

The intermediate wiring layer 30 includes a connection portion 37 that is continuous with an end portion of the outermost annular pattern 32C. The connection portion 37 and the connection portion 17 that is continuous with the end portion of the outermost annular pattern 12C of the first wiring layer 10 are electrically connected to each other by vias 18 that are conductor portions provided between the layers and configured to equalize the potentials thereof. In FIGS. 2 and 3, the vias 18 are schematically shown with a two-dot chain line. On the other hand, a portion on the end portion side of the innermost annular pattern 12A of the first wiring layer 10 and a portion on the end portion side of the innermost annular pattern 32A of the intermediate wiring layer 30 are electrically connected to each other by vias 19 that are conductors provided between the layers and configured to equalize the potentials thereof. In FIGS. 2 and 3, the vias 19 are schematically shown with a two-dot chain line. In other words, the first wiring layer 10 and the intermediate wiring layer 30 are connected in parallel between the vias 18 and the vias 19. With this configuration, the two ends of the coil-shaped first wiring layer 10 and the two ends of the coil-shaped intermediate wiring layer 30 are correspondingly electrically connected to each other, and form a coil structure in which the first wiring layer 10 and the intermediate wiring layer 30 are connected in parallel. The intermediate wiring layer 30 corresponds to an example of another wiring layer. Specifically, the intermediate wiring layer 30 corresponds to an example of a first other wiring layer that is connected in parallel to the first wiring layer 10.

As shown in FIG. 1, the second wiring layer 20 is a wiring layer that is disposed on the second plate surface 60B (second surface) side relative to the first wiring layer 10 in the substrate 60. Of the wiring layers that form the coil portion 3 (the first wiring layer 10, the second wiring layer 20, and the intermediate layers 30 and 40), the second wiring layer 20 is a wiring layer that is disposed the closest to the second plate surface 60B. In the example shown in FIG. 1, the second wiring layer 20 is disposed on the surface on the second side of the insulating layer 66, and is embedded in the substrate main body 62 so as to be covered by the insulating layer 64B. In the present specification, the second wiring layer 20 is the fourth of the wiring layers.

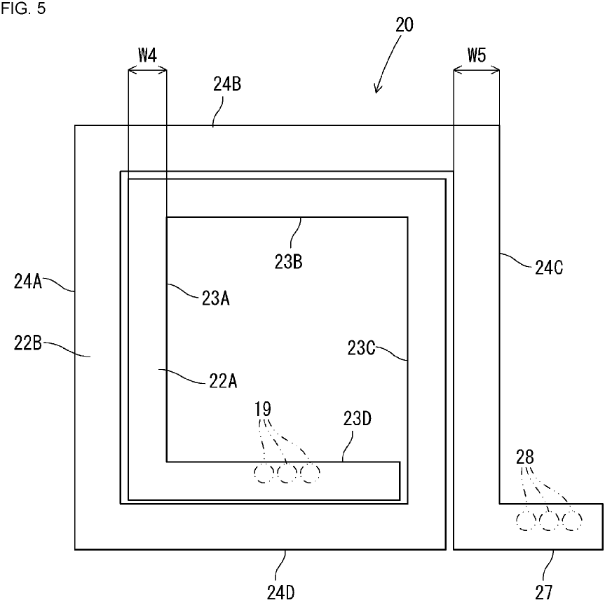

FIG. 5 is a diagram (plan view) for briefly describing the configuration of only the second wiring layer 20 of the coil component 1 as seen from above. Portions other than the second wiring layer 20 are omitted from FIG. 5. As shown FIG. 5, the second wiring layer 20 is a wiring layer configured to be wound in a coil shape. The second wiring layer 20 is disposed on a predetermined virtual plane that extends in a direction orthogonal to the thickness direction of the substrate 60, and is wound along this virtual plane.

The second wiring layer 20 includes annular patterns 22A and 22B that are provided in annular shapes. In the example shown in in FIG. 5, the second wiring layer 20 includes the annular patterns 22A and 22B (two windings) that make two laps thereof, where the number of annular patterns (number of laps) corresponds to the winding number. That is, the winding number (number of turns) of the second wiring layer 20 is two. The winding number of the second wiring layer 20 is smaller than the winding number of the first wiring layer 10.

Of the annular patterns 22A and 22B constituting the second wiring layer 20, the innermost annular pattern 22A corresponds to one example of a first annular pattern. The annular pattern 22B is provided in an annular shape on the outer side relative to the annular pattern 22A (first annular pattern). The annular pattern 22B corresponds to an example of a second annular pattern. At least a portion of the annular pattern 22B (second annular pattern) is wider than at least a portion of the annular pattern 22A (first annular pattern). Specifically, the annular patterns 22A and 22B increase in width in an outward direction.

The annular pattern 22A includes one or more second conductor patterns that are continuous with a constant width. Specifically, the annular pattern 22A includes linear patterns 23A, 23B, 23C, and 23D that are linear and have a predetermined width W4. The linear patterns 23A, 23B, 23C, and 23D correspond to an example of a second linear pattern, and an example of a second conductor pattern. The linear patterns 23A, 23B, 23C, and 23D form an integrated conductor pattern. The annular pattern 22A is configured such that the linear patterns 23A, 23B, 23C, and 23D are continuous and form a polygonal shape (specifically, a square shape) and a frame shape.

The annular pattern 22B is a conductor pattern that continues from an end portion of the annular pattern 22A. The annular pattern 22B includes one or more first conductor patterns that are continuous with a constant width. Specifically, the annular pattern 22B includes linear patterns 24A, 24B, 24C, and 24D that are linear and have a predetermined width W5. The linear patterns 24A, 24B, 24C, and 24D correspond to an example of a second linear pattern, and an example of a second conductor pattern. The linear patterns 24A, 24B, 24C, and 24D form an integrated conductor pattern. The annular pattern 22B is configured such that the linear patterns 24A, 24B, 24C, and 24D are continuous and form a polygonal shape (specifically, a square shape) and a frame shape. The annular pattern 22B is disposed on the outer side of the annular pattern 22A so as to surround the annular pattern 22A. The total length of the annular pattern 22B is larger than the total length of the annular pattern 22A. The total area of the annular pattern 22B is greater than the total area of the annular pattern 22A.

In the second wiring layer 20, the relation between the widths W4 and W5 is W4≤W5, and is more desirably W4<W5. The second wiring layer 20 includes a connection portion 27 that is connected to an end portion of the annular pattern 22B.

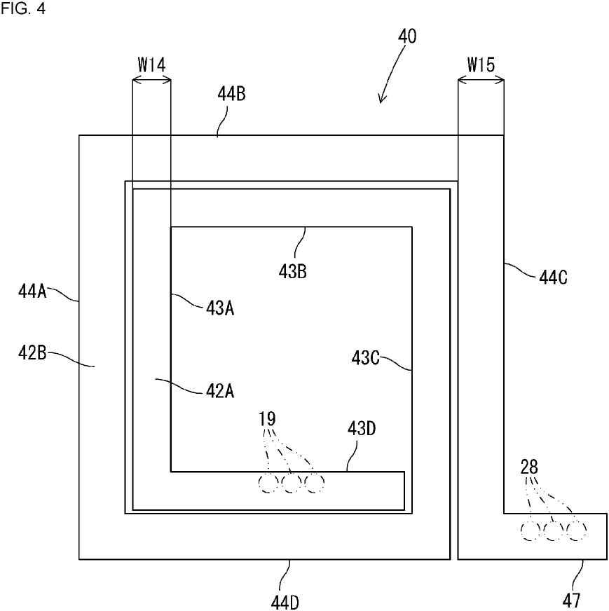

As shown in FIG. 1, the intermediate layer 40 is a wiring layer that is disposed on the first plate surface 60A (first surface) side relative to the second wiring layer 20 in the substrate 60, and disposed on the second plate surface 60B (second surface) side relative to the first wiring layer 10. The intermediate wiring layer 40 is disposed on the second plate surface 60B (second surface) side relative to the intermediate wiring layer 30. In the example shown in FIG. 1, the intermediate wiring layer 40 is embedded in the insulating layer 66. In the present specification, the intermediate wiring layer 40 is the third wiring layer. FIG. 4 is a diagram (plan view) for briefly describing the configuration of only the intermediate wiring layer 40 of the coil component 1 as seen from above. Portions other than the intermediate wiring layer 40 are omitted from FIG. 4.

As shown in FIG. 4, the intermediate wiring layer 40 is a wiring layer wound in a coil shape. The intermediate wiring layer 40 is disposed on a predetermined virtual plane that extends in a direction orthogonal to the thickness direction of the substrate 60, and is wound along this virtual plane. As shown in FIG. 4, the intermediate wiring layer 40 has the same shape as the second wiring layer 20 (FIG. 5).

The intermediate wiring layer 40 includes annular patterns 42A and 42B that are provided in annular shapes. In the example shown in FIG. 4, the intermediate wiring layer 40 includes the annular patterns 42A and 42B (two windings) that make two laps thereof, where the number of annular patterns (number of laps) corresponds to the winding number. The winding number of the intermediate wiring layer 40 is smaller than the winding number of the first wiring layer 10. Of the annular patterns 42A and 42B forming the intermediate wiring layer 40, the annular pattern 42A is disposed on the innermost side. The annular pattern 42B is provided in an annular shape on the outer side relative to the annular pattern 42A. At least a portion of the annular pattern 42B is wider than at least a portion of the annular pattern 42A.

The annular pattern 42A includes one or more conductor patterns that are continuous with a constant width. Specifically, the annular pattern 42A includes linear patterns 43A, 43B, 43C, and 43D that are linear and have a predetermined width W14. The linear patterns 43A, 43B, 43C, and 43D form an integrated conductor pattern. The annular pattern 42A is configured such that the linear patterns 43A, 43B, 43C, and 43D are continuous and form a polygonal shape (specifically, a square shape) and a frame shape.

The annular pattern 42B is a conductor pattern that continues from an end portion of the annular pattern 42A. The annular pattern 42B includes one or more conductor patterns that are continuous with a constant width. Specifically, the annular pattern 42B includes linear patterns 44A, 44B, 44C, and 44D that are linear and have a predetermined width W15. The linear patterns 44A, 44B, 44C, and 44D form an integrated conductor pattern. The annular pattern 42B is configured such that the linear patterns 44A, 44B, 44C, and 44D are continuous and form a polygonal shape (specifically, a square shape) and a frame shape. The annular pattern 42B is disposed on the outer side of the annular pattern 42A so as to surround the annular pattern 42A. The total length of the annular pattern 42B is larger than the total length of the annular pattern 42A. The total area of the annular pattern 42B is greater than the total area of the annular pattern 42A.

In the intermediate wiring layer 40, the relation between the widths W14 and W15 is W14≤W15, and is more desirably W14<W15. The relation between widths of the second wiring layer 20 and the intermediate wiring layer 40 is W4 = W14 and W5 = W15.

The intermediate wiring layer 40 includes a connection portion 47 that is continuous with an end portion of the outermost annular pattern 42B. The connection portion 47 and the connection portion 27 that is continuous with the end portion of the outermost annular pattern 22B of the second wiring layer 20 are electrically connected to each other by vias 28 that are conductor portions provided between the layers and configured to equalize the potentials thereof. In FIGS. 4 and 5, the vias 28 are schematically shown with a two-dot chain line. On the other hand, a portion on the end portion side of the innermost annular pattern 22A of the second wiring layer 20 and a portion on the end portion side of the innermost annular pattern 42A of the intermediate wiring layer 40 are electrically connected to each other by vias 19 that are conductors provided between the layers and configured to equalize the potentials thereof. In FIGS. 4 and 5, the vias 19 are schematically shown with a two-dot chain line. In other words, the second wiring layer 20 and the intermediate wiring layer 40 are connected in parallel between the via 28 and the via 19. Due to this configuration, the two ends of the coil-shaped second wiring layer 20 and the two ends of the coil-shaped intermediate wiring layer 40 are correspondingly electrically connected to each other, and form a coil structure in which the second wiring layer 20 and the intermediate wiring layer 40 are connected in parallel. The intermediate wiring layer 40 corresponds to an example of another wiring layer. Specifically, the intermediate wiring layer 40 corresponds to an example of another second wiring layer that is connected in parallel to the second wiring layer 20.

Furthermore, the end side portions on the inner side of the coil-shaped portion where the first wiring layer 10 (first layer) and the intermediate wiring layer 30 (second layer) are connected in parallel and the end side portions on the inner side of the coil-shaped portion where the second wiring layer 20 (fourth layer) and the intermediate wiring layer 40 (third layer) are connected in parallel are electrically connected by vias 19. In the coil component 1, the electrical connection of the four wiring layers can be ensured while suppressing the size of the vias 19.

In the present configuration, at least a portion of the second wiring layer 20 is wider than at least a portion of the first wiring layer 10. Specifically, portions of the second wiring layer 20 and the intermediate wiring layer 40 are respectively wider than portions of the first wiring layer 10 and the intermediate wiring layer 30. For example, the constant width of all of the second conductor patterns of the second wiring layer 20 is also wider than the constant width of all of the first conductor patterns of the first wiring layer 10. Specifically, all of the second linear patterns (linear patterns 23A to 23D and 24A to 24D) of the second wiring layer 20 are wider than all of the first linear patterns (linear patterns 13A to 13D, 14A to 14D, and 15A to 15D) of the first wiring layer 10. Furthermore, all of the second linear patterns (linear patterns 23A to 23D and 24A to 24D) of the second wiring layer 20 are wider than all of the linear patterns (linear patterns 33A to 33D, 34A to 34D, and 35A to 35D) of the intermediate wiring layer 30 connected in parallel to the first wiring layer 10. Also, all of the linear patterns (linear patterns 43A to 43D and 44A to 44D) of the intermediate wiring layer 40 connected in parallel to the second wiring layer 20 are wider than all of the first linear patterns (linear patterns 13A to 13D, 14A to 14D, and 15A to 15D) of the first wiring layer 10. Furthermore, all of the linear patterns (linear patterns 43A to 43D and 44A to 44D) of the intermediate wiring layer 40 are wider than all of the linear patterns (linear patterns 33A to 33D, 34A to 34D, and 35A to 35D) of the intermediate layer 30 connected in parallel to the first wiring layer 10. More specifically, in the coil component 1, W1≤W2≤W3≤W4≤W5 holds true, and more desirably W1<W2<W3<W4<W5 holds true.

### 2. Examples of Effects

In the coil component 1, at least a portion of the second wiring layer 20 disposed on the second plate surface 60B (second surface) side of the substrate 60 is wider than at least a portion of the first wiring layer 10 disposed on the first plate surface 60A (first surface) side of the substrate 60. Thus, in the coil component 1, the size of a wiring layer per winding can be easily suppressed on the first plate surface 60A (first surface) side of the substrate 60, and the resistance value of the wiring layer on the second plate surface 60B (second surface) side can be easily suppressed.

In the coil component 1, at least at the portions of the first conductor patterns and the second conductor patterns that are continuous with a constant width, it is possible to ensure a larger width for the second wiring layer 20 disposed on the second plate surface 60B (other surface) side of the substrate 60 than the width of the first wiring layer 10 disposed on the first plate surface 60A (first surface) side of the substrate 60.

In the coil component 1, the first wiring layer 10 has a larger winding number than the second wiring layer 20. In the first wiring layer 10 of the coil component 1 in which the conductor width is relatively suppressed, the inductance can be increased by relatively increasing the winding number, and thus an increase in the inductance in a wiring layer on the first plate surface 60A (first surface) side of the substrate 60 can be prioritized. On the other hand, in the second wiring layer 20 of the coil component 1 in which the winding number is relatively small, the resistance value can be suppressed by increasing the conductor width, and thus a reduction in the resistance value of a wiring layer on the second plate surface 60B (second surface) side of the substrate 60 can be prioritized.

In the coil component 1, the first plate surface 60A (first surface) of the substrate 60 is a surface supported by the heat dissipation portion 80, and thus heat dissipation can be promoted on the first plate surface 60A (first surface) of the surface 60. The configuration where the first wiring layer 10 is disposed on the first plate surface 60A side of the substrate 60 makes it easier to suppress the size of a wiring layer on the first plate surface 60A side, but heat generation by the first wiring layer 10 is of concern. In contrast, the coil component 1 can promote heat dissipation on the first plate surface 60A (first surface) side, and thus the size of a wiring layer on the first plate surface 60A side of the substrate 60 can be suppressed while also suppressing heat generation.

In the coil component 1, the first wiring layer 10 and the second wiring layer 20 are each provided with a first annular pattern provided in an annular shape and a second annular pattern provided in an annular shape on the outer side relative to the first annular pattern. At least a portion of the second annular pattern is wider than at least a portion of the first annular pattern. This coil component 1 can secure a larger width for the outer second annular pattern of which the path is likely to be long, and suppress the resistance voltage of the outer second annular pattern for which the resistance value is likely to be large.

In the coil component 1, the intermediate wiring layers 30 and 40 are provided as other wiring layers. In the coil component 1, the resistance values can be suppressed at the coil-shaped parallel connection portion including the first wiring layer 10 and the coil-shaped parallel connection portion including the second wiring layer 20.

### Other Embodiments

The present disclosure is not limited to the embodiments thus described using the above description and drawings. For example, features of the embodiments described above and below can be combined as necessary provided no contradiction arises. Also, features of the embodiments described above and below can also be omitted unless otherwise clearly stated as being essential. Furthermore, changes such as the following may be made to the above embodiment.

In the above embodiment, the coil component 1 employs a configuration where the first plate surface 60A (first surface) of the substrate 60 is in direct contact with the heat dissipation portion 80 and supported by the heat dissipation portion 80, but the first plate surface 60A (first surface) of the substrate 60 may be indirectly supported by the heat dissipation portion 80 via another member. The other member in this case may be a resin member, a metal member, or a member made of another material. The other member in this case may be provided in its entirety or only partially on the first plate surface 60A.

In the embodiment described above, the first wiring layer 10 and the heat dissipation portion 80 are interposed by an insulation layer, but the present disclosure is not limited to this configuration. For example, a configuration may be employed where the first wiring layer 10 is in direct contact with the heat dissipation portion 80.

In the example shown in FIG. 5, the winding number of the second wiring layer 20 is two, but even when the winding number or the second wiring layer 20 is three or more, it is sufficient that the annular patterns forming the second wiring layer 20 increase in width in an outward direction.

The embodiments disclosed herein are to be considered illustrative in all respects and not restrictive. The scope of the present disclosure is defined by the claims and not by the above description, and all changes that come within the meaning and range of equivalency of the claims are intended to be embraced therein.

1. A coil component in which a coil portion is provided on a substrate,
wherein the coil portion includes a plurality of wiring layers laminated on the substrate,
the plurality of wiring layers include a first wiring layer with a wound configuration on a first surface side of the substrate, a second wiring layer with a wound configuration on a second surface side of the substrate relative to the first wiring layer, and intermediate wiring layers respectively disposed on the first surface side of the substrate relative to the second wiring layer and on the second surface side relative to the first wiring layer,
at least a portion of the second wiring layer is wider than at least a portion of the first wiring layer,
the winding number of the first wiring layer is greater than the winding number of the second wiring layer,
the winding number of each of the intermediate wiring layers is greater than the winding number of the second wiring layer,
the first wiring layer and the intermediate wiring layers are provided in parallel to each other,
the first surface of the substrate is in contact with a heat dissipation portion and supported by the heat dissipation portion, and
a heat dissipation material of the heat dissipation portion in contact with the first surface has a higher thermal conductivity than an insulating layer forming the substrate.

2. The coil component according to claim 1, wherein the first wiring layer includes one or more first conductor patterns that are continuous with a constant width,
the second wiring layer includes one or more second conductor patterns that are continuous with a constant width, and
the constant width of all of the second conductor patterns of the second wiring layer is larger than the constant width of the all of the first conductor patterns of the first wiring layer.

3. (canceled)

4. (canceled)

5. The coil component according to claim 1, wherein at least one of the first wiring layer and the second wiring layer includes a first annular pattern provided in an annular shape, and a second annular pattern provided in an annular shape on the outer side relative to the first annular pattern, and
at least a portion of the second annular pattern is wider than at least a portion of the first annular pattern.

6. The coil component according to claim 1, wherein the plurality of wiring layers include another wiring layer with a wound configuration, and
the other wiring layer is connected in parallel to at least one of the first wiring layer and the second wiring layer.

7. The coil component according to claim 2, wherein at least one of the first wiring layer and the second wiring layer includes a first annular pattern provided in an annular shape, and a second annular pattern provided in an annular shape on the outer side relative to the first annular pattern, and
at least a portion of the second annular pattern is wider than at least a portion of the first annular pattern.

8. The coil component according to claim 2, wherein the plurality of wiring layers include another wiring layer with a wound configuration, and
the other wiring layer is connected in parallel to at least one of the first wiring layer and the second wiring layer.

9. The coil component according to claim 5, wherein the plurality of wiring layers include another wiring layer with a wound configuration, and
the other wiring layer is connected in parallel to at least one of the first wiring layer and the second wiring layer.
